(19) United States
(12) Patent Application Publication
(10) Pub. No.: US 2001/0005736 A1
(43) Pub. Date: Jun. 28, 2001

(54) Compatabilization of internal mold release agents

(76) Inventor: Andreas H. Rothacker, Hoeilaart (BE)

Correspondence Address: Patent Counsel, Huntsman Polyurethanes, 286 Mantua Grove Road, West Deptford, NJ, 08066-1732, US

(21) Appl. No.: 09/767,085

(22) Filed: Jan. 22, 2001

Related U.S. Application Data
(63) Continuation of application No. PCT/US99/17396, filed on Jul. 29, 1999.
(60) Provisional application No. 60/094,486, filed on Jul. 29, 1998.

(51) Int. Cl. C08L 75/04; C08K 5/09; C08K 5/10; C08K 5/20; C08K 5/05; C08K 5/06

(52) U.S. Cl. 524/728; 528/49; 528/48; 528/52; 525/440; 525/454; 252/182.2; 524/726; 524/773; 524/755; 524/759; 524/761; 524/765

(57) ABSTRACT

The disclosed invention relates to isocyanate reactive systems which have an internal mold release agents having improved stability. The isocyanate reactive system includes (1) at least one compound containing a plurality of isocyanate-reactive groups and (2) an internal mold release system comprising (a) a carboxylic acid and (b) a compound selected from the group consisting of a fatty polyester, a fatty acid ester and a fatty amide, and a surfactant selected rom the group consisting of ethoxylated alcohols, propoxylated alcohols or blends thereof.

### TECHNICAL FIELD

The present invention relates to polyol compositions and to internal mold release agents. The present invention further relates to the use of these polyol compositions in reaction injection molding applications.

### BACKGROUND ART

In the SRIM process, a liquid stream of polyisocyanate is impingement mixed with a stream which contains active hydrogen-containing liquids and optionally, catalysts, fillers, mold release agents, etc., and transferred to a heated metal mold. A glass mat or a mat of other structural fibers is placed into the mold prior to the impingement mixing of the components so that the final product is a reinforced composite.

SRIM processes are used to manufacture high strength, low weight urethane articles. For example, SRIM processes are used to manufacture interior trim substrates such as door panels, package trays, speaker enclosures and seat pans for automobiles.

Urethane polymers, being excellent adhesives, bond tenaciously to metal making it necessary to utilize a release agent so that parts can be quickly and easily removed from the mold without damage or distortion. To facilitate ease of removal of a molded urethane part, external mold release agents and internal mold release agents have been employed. External mold release agents are applied directly to the mold surfaces. The mold surfaces are completely covered with the release agent, generally by spraying a solution or an emulsion of a soap or wax onto the surface of the mold. This procedure requires a minimum of 30-60 seconds and must be repeated after every one to five parts, thus increasing the part to part cycle time by as much as 50%. Additionally, this constant spraying often causes excessive mold release agent to build up on areas surrounding the mold surface or on the mold surface itself. In this instance, the mold must be periodically wiped off and/or cleaned by solvent or detergent wash which is both time consuming and costly for the part manufacturer.

Internal mold release agents are employed directly within the polyurethane formulations. Internal mold release agents eliminate the difficulties associated with external mold release agents. Various internal mold release agents have been proposed. U.S. Pat. No. 3,875,069 discloses lubricant compositions useful in shaping thermoplastic material. The lubricant compositions include (A) mixed esters of (i) aliphatic, cycloaliphatic and/or aromatic dicarboxylic acids, (ii) aliphatic polyols and (iii) aliphatic monocarboxylic acids with (B) esters of (1) dicarboxylic acids and long chained aliphatic monofunctional alcohols (2) long chained aliphatic monofunctional alcohols and long-chained monocarboxylic acids and (3) full or partial esters of aliphatic polyols and long-chained aliphatic monocarboxylic acids.

U.S. Pat. No. 5,389,696 discloses a process for producing a molded foam part using an internal mold release agent which comprises (a) 1-10% of mixed esters comprising the reaction product of i) aliphatic dicarboxylic acids, ii) aliphatic polyols, and iii) monocarboxylic acids. U.S. Pat. No. 4,546,154 discloses the use of 0.5-1.5 percent by weight of polysiloxane mold release agents in reaction injection molding systems. Polysiloxane mold release agents, however, do not provide a sufficient number of releases. For example, U.S. Pat. No. 4,098,731 discloses the use of salts of saturated or unsaturated aliphatic or cycloaliphatic carboxylic acids containing at least eight carbon atoms, and tertiary amines which do not contain amide or ester groups as release agents for polyurethane foam production.

U.S. Pat. No. 4,024,090 discloses the use of esterification reaction products of polysiloxanes and monocarboxylic or polycarboxylic acids as internal mold release agents. U.S. Pat. Nos. 5,128,807, 4,058,492, 3,993,606 and 3,726,952 disclose the use of carboxylic acids or their derivatives as mold release agents.

Specific fatty acids and their esters also have been employed as mold release agents. U.S. Pat. No. 4,130,698 discloses the use of esters of a fatty acid, such as glycerol trioleate, olive oil and peanut oil, as a processing aid. Polyether polyol compositions which include fatty acid esters used as internal mold release agents, however, tend to undergo rapid phase separation due to immiscibility of the fatty acid ester with the polyol. This separation makes it difficult to transport bulk quantities of internal mold release agent-containing polyol compositions which contain fatty acid ester type internal mold release agents.

A need therefore exists for polyol compositions having internal mold release agents such as fatty acid esters which show improved resistance to phase separation.

### DISCLOSURE OF THE INVENTION

The present invention relates to isocyanate reactive systems which include polyol blends which employ internal mold release agents, particularly to internal mold release agents and surfactant. The internal mold release agents are the reaction products of a carboxylic acid and any of fatty polyester, fatty acid ester, fatty amide and combinations thereof. The surfactant is any of ethoxylated alcohols, propoxylated alcohols or blends thereof.

More specifically, the invention relates to an isocyanate reactive system comprising (1) at least one compound containing a plurality of isocyanate-reactive groups and (2) an internal mold release system comprising (a) a carboxylic acid and (b) a compound selected from the group consisting of a fatty polyester, a fatty acid ester and a fatty amide, and a surfactant selected from the group consisting of ethoxylated alcohols, propoxylated alcohols or blends thereof. The surfactant is a blend of a first component of an EO/PO mixed adduct of a monol selected from the group consisting of C₁-C₁₈ alkyl monols, C₆-C₂₀ aryl monols and mixtures thereof where

$$\frac{90}{10} \leq \frac{EO}{PO} \leq \frac{10}{90} ,$$

and the molecular weight of the mixed adduct is about 500 to about 10,000 number average, and a second component of an EO adduct of a C₈-C₁₈ aliphatic monol having a molecular weight of about 300-100,000. The surfactant may be any of surfactant A, Surfactant B, surfactant C, surfactant D, surfactant E, surfactant F, surfactant G, surfactant H and surfactant I where

surfactant A is a blend of 80% of a first component having butyl diethylene glycol ethyl ether as an initiator with 45.4 mol EO and 37.9 mol PO block copolymer with EO as tip and 20% of a second component having decyl alcohol with 5.5 mol EO,

surfactant B is a blend of 70% a first component having butyl diethylene glycol ethyl ether initiator with 45.4 mol EO and 37.9 mol PO block copolymer with EO as tip and 30% a second component having decyl alcohol with 5.5 mol EO,

surfactant C is a blend of 90% a first component having butyl diethylene glycol ethyl ether initiator with 45.4 mol EO and 37.9 mol PO block copolymer with EO as tip and 10% a second component having decyl alcohol with 5.5 mol EO,

surfactant D is 100% a first component having butyl diethylene glycol ethyl ether as initiator with 45.4 mol EO and 37.9 mol PO block copolymer with EO as tip,

surfactant E is 100% decyl alcohol with 5.5 mol EO,

surfactant F is 80% a first component having butyl diethylene glycol ethyl ether initiator with 45.4 mol EO and 37.9 mol PO block copolymer with EO as tip and 20% of a second component having oleyl alcohol with 20 mol EO,

surfactant G is a blend of 70% a first component having butyl diethylene glycol ethyl ether initiator with 45.4 mol EO and 37.9 mol PO block copolymer with EO as tip and 30% of a second component having oleyl alcohol with 20 mol EO,

surfactant H is a blend of 90% a first component having butyl diethylene glycol ethyl ether initiator with 45.4 mol EO and 37.9 mol PO block copolymer with EO as tip and 10% of a second component having oleyl alcohol with 20 mol EO, and

surfactant I is oleyl alcohol with 20 mol EO.

The invention further relates to a urethane reaction system including an organic polyisocyanate and an isocyanate reactive system including (1) at least one compound containing a plurality of isocyanate-reactive groups and (2) an internal mold release system comprising (a) a carboxylic acid and (b) a compound selected from the group consisting of a fatty polyester, a fatty acid ester and a fatty amide, and (3) a surfactant selected rom the group consisting of ethoxylated alcohols, propoxylated alcohols or blends thereof.

Having summarized the invention, the invention is described in detail below by reference to the following detailed description and non-limiting examples.

### MODES FOR CARRYING OUT THE INVENTION

### Glossary

1. Dabco 8800 is acid blocked Dabco 33LV available from Air Products.

2. Dabco® 33LV is 33% triethylene diamine in dipropylene glycol available from Air Products.

3. Kemester 5721 is tridecyl stearate available from Witco Chemicals.

4. L-5440 is a silicone surfactant available from OSI Inc.

5. Loxiol G71S is the reaction product of adipic acid, pentaerythritol and oleic acid from Henkel Corporation.

6. OSI-L-6980 is a poly(dimethylsiloxane) surfactant available from OSI Chemicals.

7. Polycat 8 is N,N-dimethyl-cyclohexyl amine catalyst available from Air Products.

8. RUBINOL R015 is a polyether diol that has a functionality of 3 and a hydroxyl number of 650 mg KOH/g available Huntsman Polyurethanes.

9. Unitol DSR is a tall oil fatty acid available from Union Camp Corp. Unitol DSR is a mixture of linear aliphatic mono acids with an average number of carbons of 18.

10. IL 2769 is a blend of 80% G5000 and 20% Renex KB from ICI Surfactants.

11. G5000 is butyl carbitol with 45.4 mol EO and 37.9 mol PO block copolymer with EO tip from ICI surfactants.

12. Renex KB is decyl alcohol with 5.5 mol EO from ICI surfactants.

13. Atlas G-3969 is a blend of 80% G5000 and 20% Brij 98 from ICI Surfactants.

14. Brij 98 is oleyl alcohol with 20 mol EO from ICI surfactants.

### Isocyanate Reactive System

The present isocyanate reactive system includes polyols, an internal mold release agent and a surfactant. In a first embodiment, the isocyanate reactive system includes a polyol in an amount of about 50 to about 100%, based on total weight of the isocyanate reactive system, an internal mold release agent in an amount of about 0.1 to about 50%, and surfactant in an amount of about 0.1 to about 50%, all amounts based on total weight of the isocyanate reactive system. The surfactant is the blend of a first component of an EO/PO mixed adduct of C₁-C₁₈ alkyl monol or C₆-C₂₀ aryl monol where

$$\frac{90}{10} \leq \frac{EO}{PO} \leq \frac{10}{90} ,$$

and the molecular weight of the mixed adduct is about 500 to about 10,000 number average, preferably about 500 to about 5000, and a second component that is an EO adduct of a C₈-C₁₈ aliphatic monol having a molecular weight of about 300 to about 100,000, preferably about 400 to about 2000. The surfactant may be about 0.1 to about 50%, preferably about 1.0 to about 20.0%, most preferably about 3% to about 5% based on the total weight of the isocyanate reactive system.

Surfactants useful in this embodiment of the invention on average have about 80% ethoxylated-propoxylated adduct of 2-(2-butoxyethoxyl)-ethanol having about 45.4 mols of ethylene oxide and about 37.9 mols of propylene oxide per initiator where EO and PO are in blocks, and 20% ethoxylated decyl alcohol having and average of about 5.5 mols of EO/initiator.

Surfactants include alkoxylated initiators such as ethoxylated initiators and propoxylated-ethoxylated initiators. Ethoxylated initiators have 1-30, preferably 4-18 carbons, a functionality of about 1-8, preferably about 1-2, and the resulting surfactant has a molecular weight of about 76-20,000, preferably about 250-6000. Propoxylated-ethoxylated initiators include 1-30 carbons, a functionality of 1-8 and the resulting surfactant has a molecular weight of about 135-20000. Preferably, a mixture of an ethoxylated alcohol with a ethoxylated-propoxylated alcohol is used as a surfactant blend. The ethoxylated alcohol is present in an amount of up to 50% of the mixture where the alcohol initiator has 4-18 carbons, a functionality of 1, and the resulting surfactant has a number average molecular weight of about 250 to about 2000. The ethoxylated-propoxylated alcohol is present in an amount of at least 50% of the mixture, the alcohol initiator has 4-10 carbons, the resulting surfactant has a molecular weight of about 2000-4000, and the EO and PO can be random or in blocks.

Especially preferred surfactants useful in this embodiment of the isocyanate reactive system of the invention includes about 10-100%, preferably about 80% butyl carbitol (butyl diethylene glycol ethyl ether) having about 45.4 mols ethylene oxide and about 37.9 mols propylene oxide (block distribution) that is made by reacting 1 mol of butyl carbitol with EO and PO using well known chemical reactions such as reaction of mono alcohols with alkylene oxides to yield polyether alcohols in the presence of a catalyst of a 1:1 mixture of KOH in water, with about 0-90%, preferably about 20% decyl alcohol having 5.5 mols ethylene oxide. This surfactant is available from ICI Surfactants, Inc. under the tradename IL-2769.

In a second embodiment, the isocyanate reactive system includes polyol in an amount of about 50% to about 100%, an internal mold release agent in an amount of about 0.1 to about 50%, and surfactant in an amount of about 0.1 to about 50%, all amounts based on total weight of the isocyanate reactive system, and a surfactant that is the blend of a first component of an EO/PO mixed adduct of C₁-C₁₈ alkyl monol or C₆-C₂₀ aryl monol where

$$\frac{90}{10} \leq \frac{EO}{PO} \leq \frac{10}{90} ,$$

with a second component that is an EO adduct of C₁₀-C₃₆ aliphatic monol having a number average molecular weight of about 400-10000, preferably about 500 to about 3000. Surfactants useful in this aspect of the invention have about 80% ethoxylated-propoxylated adduct of 2-(2-butoxyethoxyl)ethanol having an average of about 45.4 mols of randomly distributed EO and about 37.9 mols PO per initiator and about 20% ethoxylated alcohol having about 20 mols of EO per initiator. Initiators include alkoxylated initiators such as ethoxylated initiators and propoxylated-ethoxylated initiators. Ethoxylated initiators have 1-30, preferably 4-18 carbons, a functionality of about 1-8, preferably about 1-2, and the resulting surfactant has a molecular weight of about 76-20,000, preferably about 250-6000. Propoxylated-ethoxylated initiators include 1-30 carbons, a functionality of 1-8 and the resulting surfactant has a molecular wight of about 135-20000. Preferably, a mixture of an ethoxylated alcohol with an ethoxylated-propoxylated alcohol is used as a surfactant blend. The ethoxylated alcohol is present in an amount of up to 50% of the mixture, has 4-18 carbons, a functionality of 1, and a number average molecular weight of about 250-about 2000. The ethoxylated-propoxylated alcohol is present in an amount of at least 50% of the mixture, has 4-10 carbons, a molecular weight of about 2000-4000, and the EO and PO can be random or in blocks.

An especially preferred surfactant includes about 10-100%, preferably about 80% butyl carbitol (butyl diethylene glycol ethyl ether) having about 45.4 mols ethylene oxide and about 37.9 mols propylene oxide (block distribution) that is made by reacting 1 mol of butyl carbitol with EO and PO using standard chemical reactions reaction of mono alcohols with alkylene oxides to yield polyether alcohols in the presence of a catalyst of a 1:1 mixture of KOH in water, with about 0-90%, preferably about 20% oleyl alcohol with 20 mol ethylene oxide. This surfactant is available from ICI Surfactants, Inc. under the tradename Atlas G-3969. Blends of IL 2769 and ATLAS G-3969 also may be employed.

The surfactant may be about 0.1 to about 50%, preferably about 1.0-20.0%, most preferably about 3.0 to about 5.0% of the isocyanate reactive system.

The polyols employed in the isocyanate reactive systems of the invention include at least one polyol having a plurality of isocyanate-reactive groups. Combinations of polyols and other isocyanate-reactive compounds also may be employed. Optionally, at least one of these is a softblock component. Softblock components useful in the present reaction system include those conventionally used in the art. The term “softblock” is well known to those in the art. It is the soft segment of a polyurethane, realizing that the polyurethane may encompass isocyanurate rings, urea or other linkages. Materials which furnish softblock segments are well known to those skilled in the art. Such compounds generally have a number average molecular weight of at least about 1500 and preferably about 1500 to about 8000, a number-average equivalent weight of from about 400 to about 4000 preferably from about 750 to about 2500, and a number-average functionality of isocyanate-reactive groups of about 2 to about 10 and preferably from about 2 to about 4. Such compounds include e.g., polyether or polyester polyols comprising primary or secondary hydroxyl groups. Preferably, the softblock segments comprise about 0 to about 30 wt % and more preferably about 0 to about 20 wt % of the isocyanate-reactive species of the compound containing a plurality of isocyanate-reactive groups. The polyol components employed comprise (a) about 0 to about 20 wt % of at least one polyol having a molecular weight of 1500 or greater and a functionality of 2 to 4; (b) about 70-98% wt % of at least one polyol having a molecular weight of between about 200 and 500 and a functionality of about 2 to about 6; and (c) about 2 to about 15 wt % of at least one polyol having a functionality of about 2 to about 4 and a number average molecular weight of less than 200. All functionalities and molecular weights described herein with respect to polymeric materials are “number average”. All functionalities and molecular weights described with respect to pure compounds are “absolute”.

Polyols which may be employed in the isocyanate reactive systems of the invention, include polyether polyols, polyester polyols, and polyhydric polyols. Polyether polyols which may be employed may be prepared by methods well known in the art. Typically, the polyether polyols are prepared by reacting an alkylene oxide, halogen-substituted alkylene oxide or aromatic-substituted alkylene oxide or mixtures thereof with an active hydrogen-containing initiator compound. Examples of alkylene oxides include ethylene oxide, propylene oxide, 1,2-butylene oxide, styrene oxide, epichlorohydrin, epibromohydrin, and mixtures thereof. Examples of hydrogen-containing initiator compounds include water, ethylene glycol, propylene glycol, butanediol, hexanediol, glycerine, trimethylol propane, pentaerythritol, hexanetriol, sorbitol, sucrose, hydroquinone, resorcinol, catechol, bisphenols, novolac resins, phosphoric acid and mixtures thereof. Other examples of hydrogen-containing initiator compounds include ammonia, ethylenediamine, diaminopropanes, diaminobutanes, diaminopentanes, diaminohexanes, diethylenetriamine, triethylenetetramine, tetraethylenepentamine, pentamethylenehexamine, ethanolamine, aminoethylethanolamine, aniline, 2,4-toluenediamine, 2,6-toluenediamine, 2,4′-diaminodiphenylmethane, 4,4′-diaminodiphenylmethane, 1,3-phenylenediamine, 1,4-phenylenediamine, naphthylene-1,5-diamine, triphenylmethane 4,4′,4′″-triamine, 4,4′-di(methylamino)diphenylmethane, 1,3-diethyl-2,4-diaminobenzene, 2,4-diaminomesitylene, 1-methyl-3,5-diethyl-2,4-diaminobenzene, 1-methyl-3,5-diethyl-2,6-diaminobenzene, 1,3,5-triethyl-2,6-diaminobenzene, 3,5,3′,5′-tetra-ethyl-4,4′-diamino-diphenylmethane and amine aldehyde condensation products such as the polyphenylpolymethylene polyamines produced from aniline and formaldehyde and mixtures thereof.

A preferred polyether polyol for use in the isocyanate reactive systems of the invention is RUBINOL R-015 from Huntsman Polyurethanes. This polyol includes about 50 to about 100%, preferably about 80 to about 95% by weight of the isocyanate-reactive compound(s) in the present reaction systems.

Blends of polyether polyol, preferably Rubinol R-015 with glycerol, also may be used in the present invention. When blends are employed, glycerol may be present in a weight ratio of glycerol to polyol of upto about 1:1, preferably about upto about 1:10, most preferably upto about to about 1:20.

Polyester polyols which may be employed include those prepared by reacting a polycarboxylic acid or anhydride with a polyhydric alcohol. The polycarboxylic acids may be aliphatic, cycloaliphatic, aromatic and/or heterocyclic and may be substituted (e.g., with halogen atoms) and/or unsaturated. Examples of polycarboxylic acids and anhydrides include succinic acid; adipic acid; suberic acid; azelaic acid; sebacic acid; phthalic acid; isophthalic acid; terephthalic acid; trimellitic acid; phthalic acid anhydride; tetrahydrophthalic acid anhydride; hexahydrophthalic acid anhydride; tetrachlorophthalic acid anhydride; endomethylene tetrahydrophtalic acid anhydride; glutaric acid anhydride; maleic acid; maleic acid anhydride; fumaric acid; dimeric and trimeric fatty acids, such as those of oleic acid, which may be in admixture with monomeric fatty acids.

Simple esters of polycarboxylic acids may also be used, such as terephthalic acid dimethyl ester, terephthalic acid bisglycol ester and mixtures thereof. The polyester polyols may contain some terminal carboxy groups although preferably they are hydroxyl-terminated. It is also possible to use polyesters of lactones such as caprolactone, or hydroxy carboxylic acids such as hydroxy caproic acid or hydroxyacetic acid.

Polyhydric alcohols which may be employed are made by methods well known in the art. Examples of polyhydric alcohols which may be employed include ethylene glycol, 1,2-propylene glycol; 1,3-propylene glycol; 1,3-, 1,4-, 1,2- and 2,3-butylene glycol; 1,6-hexane diol; 1,8-octane diol; neopentyl glycol; cyclohexane dimethanol (1,4-bis-hydroxylmethyl cyclohexane); 2-methyl-1,3-propane diol, glycerol; trimethylol propane; 1,2,6-hexane triol; 1,2,4-butane triol; trimethylol ethylene; pentaerythritol; quitinol; mannitol; sorbitol; methylglycoside; diethylene glycol; triethylene glycol; tetraethylene glycol; polyethylene glycols; dipropylene glycol; polypropylene glycols; dibutylene glycol; polybutylene glycols and the like.

Various internal mold release agents may be employed in the isocyanate reactive systems of the invention. These internal mold release agents include the blend of a carboxylic acid and a compound selected from any of fatty polyester, fatty acid ester, fatty amide or mixtures thereof. The carboxylic acid component may be used in an amount of about 0.5 to about 5.0%, preferably about 1.5 to about 2.5%, most preferably about 2% by weight of the urethane reaction system. Any carboxylic acid compound containing an aliphatic hydrocarbon chain may be used. However, it is preferred that the carboxylic acid be liquid soluble or soluble in polyol blends. Both mono and dimer carboxylic acids may be used in concentrations of upto 95% (of the carboxylic acid component) while the trimer (and higher functionality) content of the acid compounds may range from about 1 to about 60% of the carboxylic acid compound. Useful carboxylic acid compounds have about 3 to about 100, preferably about 6 to about 54, most preferably about 18 to about 36 carbon atoms. The carboxylic acid compounds also have an acid functionality of about 1 to about 4, preferably about 1 to about 2.

Examples of carboxylic acid compounds useful in the internal mold release agents employed in the isocyanate reactive systems of the invention include polymerized oleic acid, oleic acid, adipic acid, lauric acid, stearic acid, hydroxystearic acid, terephthalic acid, behenic acid, arachidonic acid, linoleic acid, linolenic acid, ricinoleic acid and mixtures thereof. Preferably, the carboxylic acid compound is oleic acid or polymerized oleic acid available commercially as HYSTRENE® 3695, 3675 or 5460 from Witco Chemicals.

Carboxylic acid compounds useful in the internal mold release agents also include the amine salts thereof. Useful salts include those of primary, secondary and/or tertiary amines, preferably salts of tertiary amines. Although it may be formed separately, it is preferred that the carboxylic acid salt be formed by mixing carboxylic acid and amine into the bulk of the isocyanate-reactive component. Preferred tertiary aliphatic amines for use in the present invention include N,N-dimethylcyclohexylamine, triethylene diamine, bis-(dimethylamino)-diethyl ether, N-ethyl-morpholine, N,N,N′,N′,N″-pentamethyl diethylenetriamine, N,N-dimethyl aminopropylamine and aliphatic tertiary amine-containing amides of carboxylic acids, such as the amides of N,N-dimethyl aminopropylamine with stearic acid, oleic acid, hydroxystearic acid and dihydroxystearic acid. Useful tertiary aliphatic amine salts include those prepared by the reaction of oleic or polymerized oleic acid with triethanolamine, triisopropanolamine N-methyl diethanolamine, N,N-dimethyl ethanolamine and mixtures thereof. Commercially available tertiary aliphatic amines include the POLYCAT series of amines and the DABCO amine catalysts both available from Air Products Inc.

It is understood that the term “amine” as used herein is meant to include other nitrogen-containing organic bases capable of forming salts with carboxylic acids. These include amidine and guanidine compounds. Useful salts include those of tertiary aliphatic amines or aromatic amines which contain other isocyanate-reactive functional groups, such as hydroxyl groups, primary or secondary amino groups, amide groups, ester groups, urethane groups or urea groups. Moreover, it is contemplated that useful salts may contain more than one tertiary amine group per molecule.

The second component of the internal mold release agents used in the isocyanate reactive systems of the present invention is a compound selected from any of fatty polyester, a fatty acid ester, a fatty amide or mixtures thereof. The term “fatty” as used hereinabove in the context of the invention means compounds comprising 8 or more carbon atoms and preferably 12 or more carbon atoms. Preferably, these compounds are aliphatic hydrocarbons, most preferably, linear aliphatic hydrocarbons.

In general, this second component is present in the internal mold release composition in an amount of about 0.5% to about 5.0%, preferably about 1.5% to about 3.5%, most preferably about 2% based upon the weight of the entire isocyanate reactive system. Useful fatty polyesters are generally mixed esters which comprise the reaction product of three monomers: (1) a monofunctional monomer; (2) a difunctional monomer; and (3) a polyfunctional monomer (i.e., trifunctional or higher). The functionality of these monomers arises from hydroxyl groups, acid groups, or derivatives thereof. Each of monomers (1), (2) and (3) may independently comprise from about 2 to about 54 and preferably about 2 to about 18 carbon atoms.

Fatty polyesters which may be used include polyesters having a number average molecular weight of about 500 to about 12,000, preferably about 800 to about 5000, more preferably about 1000 to about 4000, most preferably about 2000 to about 3000. The fatty polyesters preferably are mixed esters of the reaction product of (i) aliphatic dicarboxylic acids, (ii) aliphatic polyols and (iii) fatty monocarboxylic acids wherein the monocarboxylic acid comprises about 12 to about 30 carbon atoms, preferably about 16 to about 20 carbon atoms. More preferably, the fatty polyesters comprise the reaction product of (i) adipic acid, (ii) pentaerythritol and (iii) oleic acid.

Examples of useful fatty polyesters include those disclosed in U.S. Pat. No. 3,875,096, the teachings of which are incorporated herein by reference. Especially suitable fatty polyesters include LOXIOL G-71S from Henkel Corporation.

Fatty acid esters useful in the internal mold release agents employed in the isocyanate reactive systems of the invention contain at least about 22 carbon atoms, preferably at least about 31 carbon atoms. The maximum number of carbon atoms in the fatty acid ester is limited only where the carbon number causes the ester to be unsuitable for blending with or into the polyol.

Fatty acid esters suitable for use in the internal mold release agents include esters of stearic acid, oleic acid, linoleic acid, linolenic acid, adipic acid, behenic acid, arachidic acid, montanic acids, isostearic acid, polymerized acids and mixtures thereof. Examples of suitable fatty acid esters include butyl stearate, tridecyl stearate, glycerol trioleate, isocetyl stearate, ditridecyl adipate, stearyl stearate, glycerol tri-(12-hydroxy) stearate, dioctyl dimerate and ethylene glycol distearate. Preferably, the fatty acid ester is tridecyl stearate. Commercially available fatty acid esters suitable for use in the present invention include the KEMESTER® series of acids available from Witco Chemical, including KEMESTER® 5721, KEMESTER® 5822, KEMESTER® 3681, KEMESTER® 5654, KEMESTER® 1000, and Priolube 1414 from Unichema Corp. Useful fatty amide compounds include (1) primary amides comprising at least 18 carbon atoms or (2) secondary or tertiary amides comprising at least 34 carbon atoms. Suitable fatty amide compounds include oleamide, stearamide, stearyl stearamide, 2-hydroxyethyl (12-hydroxy) stearamide and erucyl erucamide. Commercially available fatty amides include the KEMAMIDE® series of fatty amide compounds also available from Witco Chemical.

The isocyanate reactive systems of the invention also may include chain extenders and/or cross-linking agents. Suitable chain extenders or cross-linking agents will be evident to those skilled in the art from the present disclosure. In general, useful chain extenders are those which have a formula weight below about 750, preferably about 62 to about 750, and a functionality of about 2.

Examples of useful chain extenders include glycols such as ethylene glycol, diethylene glycol, butanediol, dipropylene glycol and tripropylene glycol; aliphatic and aromatic amines, such as 4,4′-methylene dianilines having a lower alkyl substituent positioned ortho to each N atom; imino-functional compounds such as those disclosed in European Patent Applications Nos. 284 253 and 359 456 and enamino-functional compounds such as those disclosed in European Patent Application Nos. 359 456 which have 2 isocyanate-reactive groups per molecule.

Examples of useful cross-linking agents include glycerol, oxyalkylated glycerol, pentaerythritol, sucrose, trimethylolpropane, sorbitol and oxyalkylated polyamines. The functionality of the cross-linking agents may range from 3 to about 8, preferably 3 to about 4, and the molecular weight may vary between the same ranges as disclosed above with regard to the chain extender.

A preferred class of crosslinking agents includes oxypropylated derivatives of glycerol having a number average molecular weight of about 200 to about 750, glycerol and mixtures thereof.

The isocyanate reactive systems of the invention also may contain water or other blowing agent(s). Blowing agents suitable for use with the present system are those conventionally used in the art, and include physical blowing agents such as water, chlorofluorocarbons and hydrocarbons; and chemical blowing agents, such as hydroxyfunctional cyclic ureas, etc. The blowing agents are used in amounts up to about 10%, preferably about 0.1 to about 5% and more preferably about 0.25 to about 4% by weight of the total amount of the isocyanate reactive system.

In the isocyanate reactive system of the present invention, the internal mold release agent is used in an amount of from about 1 to about 50 and preferably about 10 to about 20 parts by weight based upon the weight of the isocyanate reactive system. The isocyanate reactive systems of the invention may be prepared by any suitable method known to those skilled in the art as will be evident from the present specification.

In general, the isocyanate reactive systems can be prepared by mixing a surfactant, and an internal mold release agent into polyol. The carboxylic acid compound and the fatty polyester, fatty acid ester or fatty amide components of the internal mold release agent are generally not reacted prior to addition of the internal mold release agent to the isocyanate reactive composition. The polyol blends can be prepared by simply blending all polyol components listed for each sample and formulation in a standard mixing vessel.

Components of the present formulations which are solid materials at room temperature were first melted and then added to a heated mixture of the polyol component under high shear mixing to prepare the B side of the reaction system. The blend was maintained at a temperature high enough so that the internal mold release system would not be precipitated during its addition. The blend was then allowed to cool during mixing. After cooling, water and catalyst were added to form the final “B side” mixture.

The present invention further relates to polyurethane reaction systems for use in SRIM processes comprising, in part, the present isocyanate reactive systems having an internal mold release agents and surfactant. The polyurethane reaction systems comprise an organic polyisocyanate and the isocyanate reactive system of the invention. Organic polyisocyanates useful in the polyurethane reactions systems of invention have a number average isocyanate functionality of from about 1.8 to about 4.0, preferably from about 2.3 to about 3.0. Aromatic polyisocyanates are preferred for use in the present reaction systems. Organic polyisocyanates which may be used include any of the aliphatic, cycloaliphatic, araliphatic, or aromatic polyisocyanates known to those skilled in the art, especially those that are liquid at room temperature. Examples of suitable polyisocyanates include 4,4′-MDI, 2,4′-MDI, polymeric MDI, MDI variants and mixtures thereof. Isocyanate-terminated prepolymers may also be employed. Such prepolymers are generally prepared by reacting an excess of polymeric or pure isocyanate with polyols, including aminated polyols, imine- or enamine-modified polyols, polyether polyols, polyester polyols or polyamines. Psuedoprepolymers, which are a mixture of prepolymer and one or more monomeric di- or polyisocyanates, may also be used. 1,6-hexamethylene diisocyanate, isophorone diisocyanate, 1,4-cyclohexane diisocyanate, 4,4′dicyclohexylmethane diisocyanate, 1,4-xylylene diisocyanate, 1,4-phenylene diisocyanate, 2,4-toluene diisocyanate, 2,6-toluene diisocyanate, 4,4′diphenylmethane diisocyanate (4,4′-MDI), 2,4′diphenylmethane diisocyanate (2,4′-MDI), polymethylene polyphenylene polyisocyanates (crude or polymeric MDI) and 1,5 naphthylene diisocyanate. Mixtures of these polyisocyanates can also be used. Moreover, polyisocyanate variants, i.e., polyisocyanates which have been modified by the introduction of urethane, allophanate, urea, biuret, carbodiimide, uretonimine, isocyanurate and/or oxazolidone residues can also be used in the present systems.

Commercially available polyisocyanates useful in the present reaction systems include the RUBINATE series of polymeric isocyanates available from Huntsman Polyurethanes.

The present urethane reaction systems may further include conventionally used additives, such as flame retardants and catalysts, as needed for particular applications. Useful flame retardants include phosphonates, phosphites and phosphates, such as tris-(2-chloroisopropyl) phosphate (TCPP), dimethyl methyl phosphonate, ammonium polyphosphate and various cyclic phosphates and phosphonate esters known in the art; halogen-containing compounds known in the art, such as brominated diphenyl ether and other brominated aromatic compounds; melamine; antimony oxides, such as antimony pentoxide and antimony trioxide; zinc compounds such as zinc oxide; alumina trihydrate; and magnesium compounds, such as magnesium hydroxide. The flame retardants may be used in any suitable amount which will be evident to those skilled in the art from the present disclaimers. However, it is preferred that the flame retardant be used in an amount of 0 to 55% of the B side of the system. Useful catalysts include tertiary amines, organometallic compounds and amides of saturated or unsaturated C₁₂-C₂₄ fatty acids and di, tri or tetra-aminoalkanes having at least one catalytic amino group and at least one reactive amino group. Fatty amido-amines having hydroxyl substituents may also be used. A particularly preferred amido-amine compound is the reaction product N,N-dimethyl propyl diamine and a mixed fatty carboxylic acid available as BUSPERSE® 47 from Buckman Laboratories. The catalysts are used in amounts necessary for a particular application which will be evident to one skilled in the art from the present disclosure.

Other conventional additives generally used in the art may also be used with the reaction systems of the present invention. Examples of suitable additives include fillers, such as calcium carbonate, silica, mica, wollastonite, wood flour, melamine, glass or mineral fibers, glass spheres, etc.; pigments; surfactants; and plasticizers. Such additives will be used in amounts which will be evident to one skilled in the art from the present disclosure.

The polyurethane reaction systems of the present invention may be prepared by any conventional method which will be evident to one skilled in the art from the present disclosure. For example, the polyisocyanate component (or A side) of the reaction system may be mixed with the B side in conventional low or high pressure impingement mixing machines known in the art. The polyisocyanate component and the isocyanate-reaction system are mixed at suitable weight ratios such that the ratio of the number of isocyanate groups to isocyanate-reactive groups (commonly known as the index) is from about 75 to about 150%. When catalysts for the trimerization of isocyanates are used, the index may extend up to about 500%. Preferably, the index is from about 90 to about 115, more preferably about 95 to about 105%.

The present invention is still further directed to a process for producing molded polyurethane articles comprising reacting (1) an organic polyisocyanate with (2) an isocyanate reactive composition including a polyol composition having a plurality of isocyanate-reactive groups, (3) an internal mold release agent comprising (a) a carboxylic acid and (b) a fatty polyester, a fatty ester, a fatty amide or mixtures thereof, and a surfactant.

The present invention is especially suitable for use with SRIM techniques which utilize a closed mold. However, the invention will find application in open mold processes which utilize spray techniques, i.e., where the resin system is first sprayed over the mat and then the system is allowed to cure either in an open or closed mold.

Parts prepared with SRIM processes are usually prepared with a reinforcement mat pre-placed in the mold. The reaction system is injected into the closed mold over the mat. The resulting part is a mat-reinforced composite which is demolded after the reaction system cures.

The reaction systems of the present invention may be used with any reinforcement mat conventionally used in the SRIM art. Suitable reinforcement mats include woven or non-woven structural fibers such as glass, carbon, metal, graphite, silicon carbide, alumina, titania, boron, cellulosic, lignocellulosic, aromatic polyamide, polyester, polyolefin and mixtures thereof. The final reinforced molded article may contain between 0.5 to about 95 wt % and preferably about 10 to about 70 wt % of the reinforcing material. The diameter of the fibers is not critical and may vary from about 0.001 to about 1.0 mm. The mat may be optionally pretreated with sizing agents, coatings, adhesion promoters and other kinds of surface treatments known in the art.

In the process for producing molded articles according to the present invention, the surfaces of the molds must be pre-treated with known external mold release agents or mixtures thereof. For example, the mold surfaces may be treated with conventional external mold release agents such as soaps; and waxes, e.g., carnuba wax, montan wax, etc.; and mixtures thereof. It is preferred that the external release agents(s) used have a high melting point and demonstrate little or no transfer to the molded parts.

The present invention will now be illustrated by reference to the following non-limiting examples with specific reference to the preferred isocyanate reactive composition shown in Table 1. Although the composition of Table 1 is preferred, it is to be understood that the components of the composition of Table 1 can vary. Accordingly, Glycerine may be present in an amount of 0-10 parts, Polycat 8 may be present in an amount of 0-4.0 parts, Dabco 8800 may be present in an amount of 0-2.0 parts, Unitol DSR may be present in an amount of 5-10 parts, Loxiol G71S may be present in an amount of 5-10 parts, Kemester 5721 may be present in an amount of 1-2 parts, OSI-L-6980 may be present in an amount of 1.0-1.5 parts, and water may be present in an amount of 1.0-2.0 parts.

### EXAMPLES

Examples 1-18 illustrate manufacture of polyol compositions of the invention which have improved resistance to separation.

The polyol compositions presented in Examples 1-18 in Table 2 are prepared by mixing the composition shown in Table 1 with the amounts of IL-2769 and Atlas G-3969 surfactants shown in Table 2. The time periods of mixing and the shear rate employed during mixing are also illustrated in Table 2. All amounts shown in Tables 1 and 2 are in parts by weight. The time period to phase separation of the isocyanate reactive composition of Table 1 is shown in Table 3.

TABLE 1

| Material | Amount |
|---|---|
| Rubinol R-015 | 100.0 |
| Glycerine | 7.5 |
| Polycat 8 | 3.5 |
| Dabco 8800 | 1.0 |
| Unitol DSR | 6.5 |
| Loxiol G71S | 10.0 |
| Kemester 5721 | 1.1 |
| OSI-L-6980 | 1.5 |
| Water | 1.6 |

TABLE 2

| | | | | | Mix Time | Mixing |
|---|---|---|---|---|---|---|
| Ex. | Temp. F | IL-2769 | Atlas G-3969 | PU¹ | (Sec.) | Rate² |
| 1 | 60 | — | — | 1.0 | 120 | Low |
| 2 | 60 | — | 0.025 | 0.98 | 120 | Low |
| 3 | 60 | — | 0.050 | 0.95 | 120 | Low |
| 4 | 60 | 0.025 | 0.025 | 0.95 | 120 | Low |
| 5 | 60 | 0.025 | — | 0.98 | 120 | Low |
| 6 | 60 | 0.050 | — | 0.95 | 120 | Low |
| 7 | 80 | — | — | 1.0 | 120 | Low |
| 8 | 80 | — | 0.025 | 0.98 | 120 | Low |
| 9 | 80 | 0.025 | 0.025 | 0.95 | 120 | Low |
| 10 | 100 | — | — | 1.0 | 120 | Low |
| 11 | 100 | — | — | 1.0 | 120 | Low |
| 12 | 100 | — | 0.025 | 0.98 | 120 | Low |
| 13 | 100 | — | 0.050 | 0.95 | 120 | Low |
| 14 | 100 | 0.025 | 0.025 | 0.95 | 120 | Low |
| 15 | 100 | 0.025 | — | 0.98 | 120 | Low |
| 16 | 100 | 0.050 | — | 0.95 | 120 | Low |
| 17 | 100 | 0.050 | — | 0.95 | 120 | Low |
| 18 | 60 | — | — | 1.0 | 240 | High |

¹Polyurethane
²Shear Rate: Hi-variac speed control speed setting at 40% of 140 V
Low-Variac speed control setting at 40% of 120 V

TABLE 3

| Ex./ | | | 48 | 60 | 75 | 96 | 136 |
|---|---|---|---|---|---|---|---|
| Time | 24 Hrs. | 42 Hrs. | Hrs. | Hrs. | Hrs. | Hrs. | Hrs. |
| 1 | Separation¹ | Separation | — | — | — | — | — |
| 2 | Gelling² | Separation | no | no | no | no | no |
| | | | sep.⁴ | sep.⁴ | sep.⁴ | sep.⁴ | sep.⁴ |
| 3 | Gelling² | no sep.⁴ | no | no | no | no | no |
| | | | sep.⁴ | sep.⁴ | sep.⁴ | sep.⁴ | sep.⁴ |
| 4 | Gelling² | no sep.⁴ | no | no | no | no | no |
| | | | sep.⁴ | sep.⁴ | sep.⁴ | sep.⁴ | sep.⁴ |
| 5 | Gelling² | no sep.⁴ | no | no | no | no | no |
| | | | sep.⁴ | sep.⁴ | sep.⁴ | sep.⁴ | sep.⁴ |
| 6 | Gelling² | no sep.⁴ | no | no | no | no | no |
| | | | sep.⁴ | sep.⁴ | sep.⁴ | sep.⁴ | sep.⁴ |
| 7 | Separation¹ | Separation | — | — | — | — | — |
| 8 | Separation³ | — | — | — | — | — | — |
| 9 | Separation | no sep.⁴ | no | no | no | no | no |
| | | | sep.⁴ | sep.⁴ | sep.⁴ | sep.⁴ | sep.⁴ |
| 10 | Separation | — | — | — | — | — | |
| 11 | Separation | — | — | — | — | — | — |
| 12 | Separation | — | — | — | — | — | — |
| 13 | Separation | — | — | — | — | — | — |
| 14 | Separation | — | — | — | — | — | — |
| 15 | Separation | — | — | — | — | — | — |
| 16 | Separation | — | — | — | — | — | — |
| 17 | Separation | — | — | — | — | — | — |
| 18 | Separation | — | — | — | — | — | — |

¹Onset of micelle formation observed.
²Gelling- no separation
³(50% clear; 50% gelled); no distinct layer of Internal mold release agent
⁴No separation

In another aspect of the invention, various surfactant derivatives based on IL-2769 are evaluated for their ability to stabilize internal mold release agents which include carboxylic acids, especially Unitol DSR and fatty esters, especially Kemester 5721. These surfactant derivatives are prepared by blending of components. The resulting surfactant derivative is blended with the isocyanate reactive composition shown in Table 1 which includes the internal mold release agent having carboxylic acid and fatty ester. The results are shown in Table 4. In Table 4, surfactant A is a blend of 80% G5000 and 20% Renex KB and thus is a blend of 80% of a first component having butyl diethylene glycol ethyl ether as an initiator with 45.4 mol EO and 37.9 mol PO block copolymer with EO as tip and 20% of a second component having decyl alcohol with 5.5 mol EO, surfactant B is a blend of 70% G5000 and 30% Renex KB and thus is a blend of 70% a first component having butyl diethylene glycol ethyl ether initiator with 45.4 mol EO and 37.9 mol PO block copolymer with EO as tip and 30% a second component having decyl alcohol with 5.5 mol EO, surfactant C is a blend of 90% G5000 and 10% Renex KB and thus is a blend of 90% a first component having butyl diethylene glycol ethyl ether initiator with 45.4 mol EO and 37.9 mol PO block copolymer with EO as tip and 10% a second component having decyl alcohol with 5.5 mol EO, surfactant D is 100% G5000 and thus is butyl diethylene glycol ethyl ether as initiator with 45.4 mol EO and 37.9 mol PO block copolymer with EO as tip, surfactant E is 100% Renex KB and thus 100% decyl alcohol with 5.5 mol EO, surfactant F is a blend of 80% G5000 and 20% Brij 98 and thus is a blend of 80% a first component having butyl diethylene glycol ethyl ether initiator with 45.4 mol EO and 37.9 mol PO block copolymer with EO as tip and 20% of a second component having oleyl alcohol with 20 mol EO, surfactant G is a blend of 70% G5000 and 30% Brij 98 and thus is a blend of 70% a first component having butyl diethylene glycol ethyl ether initiator with 45.4 mol EO and 37.9 mol PO block copolymer with EO as tip and 30% of a second component having oleyl alcohol with 20 mol EO, surfactant H is a blend of 90% G5000 and 10% Brij 98 and thus is a blend of 90% a first component having butyl diethylene glycol ethyl ether initiator with 45.4 mol EO and 37.9 mol PO block copolymer with EO as tip and 10% of a second component having oleyl alcohol with 20 mol EO, and surfactant I is 100% Brij 98 and thus is oleyl alcohol with 20 mol EO.

TABLE 4
Effect of Surfactant Derivatives on Stabilization of Internal Mold Release Agent including Loxiol G71S Fatty Ester

| | Surfactant | Surfactant | 19 | | | | | | | |
|---|---|---|---|---|---|---|---|---|---|---|
| Example # | Type | Amount | hours | 48 hours | 5 days | 6 days | 12 days | 14 days | 19 day | 57 days |
| 19 | None | 0% | Onset | Separation | | | | | | |
| 20 | None | 0% | Onset | Separation | | | | | | |
| 21 | A | 3% | No Sep¹ | No Sep | No Sep (SM)² | No Sep | No Sep (SM)² | No Sep | No Sep - SM | ** |
| | | | | (SM)² | | (SM)² | | (SM)² | | |
| 22 | A | 5% | No Sep | No Sep | No Sep (SM)² | No Sep | ** | ** | ** | ** |
| | | | | (SM)² | | (SM)² | | | | |
| 23 | B | 3% | No Sep | No Sep | No Sep | No Sep | ** | ** | ** | ** |
| 24 | B | 5% | No Sep | No Sep | No Sep (SM)² | No Sep | ** | ** | ** | ** |
| | | | | (SM)² | | (SM)² | | | | |
| 25 | C | 3% | No Sep | No Sep | No Sep (SM)² | No Sep | No Sep (SM)² | No Sep | No Sep - SM | ** |
| | | | | (SM)² | | (SM)² | | (SM)² | | |
| 26 | C | 5% | No Sep | No Sep | No Sep | No Sep | No Sep | No Sep | No Sep | ** |
| 27 | D | 3% | No Sep | No Sep | No Sep (SM)² | No Sep | No Sep (SM)² | No Sep | No Sep (SM)² | ** |
| | | | | (SM)² | | (SM)² | | (SM)² | | |
| 28 | D | 5% | No Sep | No Sep | No Sep (SM)² | No Sep | No Sep (SM)² | No Sep | No Sep (SM)² | No Sep |
| | | | | (SM)² | | (SM)² | | (SM)² | | (SM)² |
| 29 | E | 3% | No Sep | Separation | | | | | | |
| 30 | E | 5% | No Sep | Separation | | | | | | |
| 31 | F | 3% | No Sep | No Sep | No Sep | No Sep | ** | ** | ** | ** |
| 32 | F | 5% | No Sep | No Sep | No Sep | No Sep | No Sep | No Sep | No Sep | No Sep |
| 33 | G | 3% | No Sep | No Sep | No Sep | No Sep | ** | ** | ** | ** |
| 34 | G | 5% | No Sep | No Sep | No Sep | No Sep | No Sep | No Sep | No Sep | No Sep |
| 35 | H | 3% | No Sep | No Sep | No Sep | No Sep | ** | ** | ** | ** |
| 36 | H | 5% | No Sep | No Sep | No Sep | No Sep | No Sep | No Sep | No Sep | No Sep |
| 37 | I | 3% | No Sep | Separation | | | | | | |
| 38 | I | 5% | * | | | | | | | |
| 39 | IL-2769 | 3% | No Sep | No Sep | No Sep | No Sep | ** | ** | ** | ** |
| 40 | IL-2769 | 5% | No Sep | No Sep | No Sep | No Sep | ** | ** | ** | ** |

¹No Sep. - No separation
²No Sep (SM) -- blend has formed small micelles of Internal Mold Release Agent (“IMR”) at the top around the glass surface, where separation is defined by a continuous layer of IMR across the top surface
³* - During addition of melted surfactant, the surfactant cooled enough to solidify in the transfer pipette; it appears that a layer of resolidified additive is floating in the top ⅓ of the blend.
⁴** - Clear layer on bottom; possibly glycerine @5-10% in the blend; yet no IMR separation

As is clear from the results above, the isocyanate reactive systems of the invention which include surfactants of any of ethoxylated alcohols, propoxylated alcohols or blends thereof increases the stability of the internal mold release agent in the isocyanate reactive system. In addition, the homogeneity of the isocyanate reactive system is increased. Also, the energy required to remix the isocyanate reactive system following separation is reduced.

The present invention may be embodied in other specific forms without departing from the spirit and essential attributes thereof and accordingly, reference should be made to the appended claims, rather than to the foregoing specification as indicating the scope of the invention.

1. An isocyanate reactive system comprising (1) at least one compound containing a plurality of isocyanate-reactive groups and (2) an internal mold release system comprising (a) a carboxylic acid and (b) a compound selected from the group consisting of a fatty polyester, a fatty acid ester and a fatty amide, and
a surfactant selected from the group consisting of ethoxylated mono-alcohols, propoxylated mono-alcohols or blends thereof.

2. The isocyanate reactive system of claim 1 wherein the surfactant is a blend of a first component of an EO/PO mixed adduct of a monol selected from the group consisting of C₁-C₁₈ alkyl monols, C₆-C₂₀ aryl monols and mixtures thereof where
$$\frac{90}{10} \leq \frac{EO}{PO} \leq \frac{10}{90} ,$$
and the molecular weight of the first component is about 500 to about 10,000 number average, and a second component of an EO adduct of a C₈-C₁₈ aliphatic monol having a molecular weight of about 300-100,000.

3. The isocyanate reactive system of claim 2 wherein the molecular weight of the first component is about 500 to about 5000, and the second component that is an EO adduct of a C₈-C₁₈ aliphatic monol has a molecular weight of about 400 to about 2000.

4. The isocyanate reactive system of claim 3 wherein the surfactant has about 80% of an ethoxylated-propoxylated adduct of 2-(2-butoxyethoxyl)-ethanol having about 45.4 mols of ethylene oxide and about 37.9 mols of propylene oxide per initiator where EO and PO are in blocks, and 20% ethoxylated decyl alcohol having and average of about 5.5 mols of EO per initiator.

5. The isocyanate reactive system of claim 1 wherein the surfactant is a blend of a first component of an EO/PO mixed adduct of C₁-C₁₈ alkyl monol or C₆-C₂₀ aryl monol where
$$\frac{90}{10} \leq \frac{EO}{PO} \leq \frac{10}{90} ,$$
with a second component that is an EO adduct of C₁₀-C₃₆ aliphatic monol having a number average molecular weight of about 400-10000.

6. The isocyanate reactive system of claim 5 wherein the second component is an EO adduct of C₁₀-C₃₆ aliphatic monol having a number average molecular weight of about 500 to about 3000.

7. The isocyanate reactive system of claim 6 wherein the surfactant has about 80 wt. % ethoxylated-propoxylated adduct of 2-(2-butoxyethoxyl)ethanol having an average of about 45.4 mols of randomly distributed EO and about 37.9 mols PO per initiator and about 20 wt. % ethoxylated alcohol having about 20 mols of EO per initiator.

8. The isocyanate reactive system of claim 3 wherein the surfactant is present in an amount of about 0.1 to about 50% of total weight of the isocyanate reactive system.

9. The isocyanate reactive system of claim 8 wherein the surfactant is selected from the group consisting of surfactant A, Surfactant B, surfactant C, surfactant D, surfactant E, surfactant F, surfactant G, surfactant H and surfactant I where
surfactant A is a blend of 80% of a first component having butyl diethylene glycol ethyl ether as an initiator with 45.4 mol EO and 37.9 mol PO block copolymer with EO as tip and 20% of a second component having decyl alcohol with 5.5 mol EO,
surfactant B is a blend of 70% a first component having butyl diethylene glycol ethyl ether initiator with 45.4 mol EO and 37.9 mol PO block copolymer with EO as tip and 30% a second component having decyl alcohol with 5.5 mol EO,
surfactant C is a blend of 90% a first component having butyl diethylene glycol ethyl ether initiator with 45.4 mol EO and 37.9 mol PO block copolymer with EO as tip and 10% a second component having decyl alcohol with 5.5 mol EO,
surfactant D is 100% a first component having butyl diethylene glycol ethyl ether as initiator with 45.4 mol EO and 37.9 mol PO block copolymer with EO as tip,
surfactant E is 100% decyl alcohol with 5.5 mol EO,
surfactant F is 80% a first component having butyl diethylene glycol ethyl ether initiator with 45.4 mol EO and 37.9 mol PO block copolymer with EO as tip and 20% of a second component having oleyl alcohol with 20 mol EO,
surfactant G is a blend of 70% a first component having butyl diethylene glycol ethyl ether initiator with 45.4 mol EO and 37.9 mol PO block copolymer with EO as tip and 30% of a second component having oleyl alcohol with 20 mol EO,
surfactant H is a blend of 90% a first component having butyl diethylene glycol ethyl ether initiator with 45.4 mol EO and 37.9 mol PO block copolymer with EO as tip and 10% of a second component having oleyl alcohol with 20 mol EO, and
surfactant I is oleyl alcohol with 20 mol EO.

10. The isocyanate reactive system of claim 9 wherein the surfactant is present in an amount of about 1.0 to about 20.0%.

11. The isocyanate reactive system of claim 10 wherein the surfactant is present in an amount of about 3% to about 5% of the isocyanate reactive system.

12. The isocyanate reactive system of claim 11 wherein the surfactant is selected from the group comprising surfactant F, surfactant G and surfactant H.

13. A urethane reaction system comprising an organic polyisocyanate and an isocyanate reactive system comprising
(1) at least one compound containing a plurality of isocyanate-reactive groups and (2) an internal mold release system comprising (a) a carboxylic acid and (b) a compound selected from the group consisting of a fatty polyester, a fatty acid ester and a fatty amide, and
a surfactant selected rom the group consisting of ethoxylated mono-alcohols, propoxylated mono-alcohols or blends thereof.

14. The urethane reaction system of claim 13 wherein the surfactant is a blend of a first component of an EO/PO mixed adduct of a monol selected from the group consisting of C₁-C₁₈ alkyl monols, C₆-C₂₀ aryl monols and mixtures thereof where
$$\frac{90}{10} \leq \frac{EO}{PO} \leq \frac{10}{90} ,$$
and the molecular weight of the mixed adduct is about 500 to about 10,000 number average, and a second component of an EO adduct of a C₈-C₁₈ aliphatic monol having a number average molecular weight of about 300-100,000.

15. The urethane reaction system of claim 14 wherein the molecular weight of the mixed adduct is about 500 to about 5000, and the second component that is an EO adduct of a C₈-C₁₈ aliphatic monol has a molecular weight of about 400 to about 2000.

16. The urethane reaction system of claim 15 wherein the surfactant has about 80 wt. % of an ethoxylated-propoxylated adduct of 2-(2-butoxyethoxyl)-ethanol having about 45.4 mols of ethylene oxide and about 37.9 mols of propylene oxide per initiator where EO and PO are in blocks, and 20 wt. % ethoxylated decyl alcohol having and average of about 5.5 mols of EO per initiator.

17. The urethane reaction system of claim 13 wherein the surfactant is a blend of a first component of an EO/PO mixed adduct of C₁-C₁₈ alkyl monol or C₆-C₂₀ aryl monol where
$$\frac{90}{10} \leq \frac{EO}{PO} \leq \frac{10}{90} ,$$
with a second component that is an EO adduct of C₁₀-C₃₆ aliphatic monol having a number average molecular weight of about 400-10000.

18. The urethane reaction system of claim 17 wherein the second component is an EO adduct of C₁₀-C₃₆ aliphatic monol, the adduct having a number average molecular weight of about 500 to about 3000.

19. The urethane reaction system of claim 18 wherein the surfactant has about 80% ethoxylated-propoxylated adduct of 2-(2-butoxyethoxyl)ethanol having an average of about 45.4 mols of randomly distributed EO and about 37.9 mols PO per initiator and about 20% ethoxylated alcohol having about 20 mols of EO per initiator.

20. The urethane reaction system of claim 15 wherein the surfactant is present in an amount of about 0.1 to about 50% of total weight of the isocyanate reactive system.

21. The urethane reaction system of claim 20 wherein the surfactant is selected from the group consisting of surfactant A, Surfactant B, surfactant C, surfactant D, surfactant E, surfactant F, surfactant G, surfactant H and surfactant I where
surfactant A is a blend of 80% of a first component having butyl diethylene glycol ethyl ether as an initiator with 45.4 mol EO and 37.9 mol PO block copolymer with EO as tip and 20% of a second component having decyl alcohol with 5.5 mol EO,
surfactant B is a blend of 70% a first component having butyl diethylene glycol ethyl ether initiator with 45.4 mol EO and 37.9 mol PO block copolymer with EO as tip and 30% a second component having decyl alcohol with 5.5 mol EO,
surfactant C is a blend of 90% a first component having butyl diethylene glycol ethyl ether initiator with 45.4 mol EO and 37.9 mol PO block copolymer with EO as tip and 10% a second component having decyl alcohol with 5.5 mol EO,
surfactant D is 100% a first component having butyl diethylene glycol ethyl ether as initiator with 45.4 mol EO and 37.9 mol PO block copolymer with EO as tip,
surfactant E is 100% decyl alcohol with 5.5 mol EO,
surfactant F is 80% a first component having butyl diethylene glycol ethyl ether initiator with 45.4 mol EO and 37.9 mol PO block copolymer with EO as tip and 20% of a second component having oleyl alcohol with 20 mol EO,
surfactant G is a blend of 70% a first component having butyl diethylene glycol ethyl ether initiator with 45.4 mol EO and 37.9 mol PO block copolymer with EO as tip and 30% of a second component having oleyl alcohol with 20 mol EO,
surfactant H is a blend of 90% a first component having butyl diethylene glycol ethyl ether initiator with 45.4 mol EO and 37.9 mol PO block copolymer with EO as tip and 10% of a second component having oleyl alcohol with 20 mol EO, and
surfactant I is oleyl alcohol with 20 mol EO.

22. The urethane reaction system of claim 21 wherein the surfactant is present in an amount of about 1.0 to about 20.0%.

23. The urethane reaction system of claim 22 wherein the surfactant is present in an amount of about 3% to about 5% of the urethane reaction system.

24. The urethane reaction system of claim 23 wherein the surfactant is selected from the group comprising surfactant F, surfactant G and surfactant H.
